(19) United States
(12) Patent Application Publication
(10) Pub. No.: US 2025/0100401 A1
(43) Pub. Date: Mar. 27, 2025

(54) ROAD CONSTRUCTION MACHINE

(71) Applicant: JOSEPH VÖGELE AG, Ludwigshafen/Rhein (DE)

(72) Inventor: Klaus OETTINGER, Altlußheim (DE)

(73) Assignee: JOSEPH VÖGELE AG, Ludwigshafen/Rhein (DE)

(21) Appl. No.: 18/891,243

(22) Filed: Sep. 20, 2024

(30) Foreign Application Priority Data
Sep. 21, 2023 (EP) 23198702.5

(51) Int. Cl. B60L 50/60; B60L 15/00

(52) U.S. Cl. CPC B60L 50/66; B60L 15/007; B60L 2200/40

(57) ABSTRACT

The disclosure relates to a road construction machine comprising a chassis, a driving gear, a plurality of working aggregates for installing or removing a road surface and/or conveying a paving material, one or more individual drives, which are adapted in particular to power the driving gear and/or the working aggregates, a primary drive system for powering the one or more individual drives of the road construction machine, and an interface which is adapted to connect the primary drive system to the one or more individual drives in a coupleable manner, in particular to enable the one or more individual drives to be supplied with power from the primary drive system, and wherein the primary drive system is adapted to be replaceable.

### CROSS-REFERENCE TO RELATED APPLICATIONS

This application claims foreign priority benefits under 35 U.S.C. § 119 (a)-(d) to European patent application number EP 23198702.5, filed Sep. 21, 2023, which is incorporated by reference in its entirety.

### TECHNICAL FIELD

The disclosure relates to a road construction machine and a method of assembling a road construction machine.

### BACKGROUND

Road pavers (or asphalt pavers) are road construction machines that are mainly used for paving asphalt mixes in road construction. The main components of a road paver typically comprise a driving gear, a material container (receptacle or hopper), scraper belts, a distribution screw, a screed, a heating system and an automatic leveling system.

A diesel-hydraulic drive system for a road paver is known from EP 2333158 B2, where the energy required to operate the road paver is provided by a combustion engine or by a diesel engine (primary drive source). EP 2333158 B2 further discloses that the diesel engine is connected directly to hydraulic pumps and, on the other hand, directly to the generator.

The use of diesel-electric drive systems in road construction machines is also well known. The diesel-electric drive contains a transmission system with which the mechanical energy provided by diesel engines is converted into electrical power with the help of a generator and transferred to the electric individual drive.

In recent years, emission reduction targets have driven the electrification of road construction machines, and road construction machines that feature an electric motor as their primary drive source are now state of the art.

The availability of electricity or other emission-free energy sources and exhaust emission standards vary in different countries. It is very costly for road construction machine manufacturers to produce a machine type based on a suitable drive concept, depending on the emission legislation and infrastructure of the countries for the emission-free energy sources.

### SUMMARY

An object of the disclosure is to provide a single type of road construction machine in which the primary drive system may be adapted or replaced with little effort. For example, depending on the available energy source and emissions legislation in different countries, it may be necessary to use a different primary drive system.

This object is solved by embodiments according to the disclosure.

According to a first aspect, the disclosure relates to a road construction machine comprising a chassis and a driving gear. The road construction machine may further comprise one or more working aggregates for installing or removing a road surface and/or for conveying a paving material. The road construction machine comprises a primary drive system, one or more individual drives and an interface. The individual drives may be adapted to power the driving gear and/or the working aggregates. The primary drive system is adapted to power the one or more individual drives of the road construction machine. The primary drive system may be connected to the one or more individual drives via the interface. In particular, this enables the one or more individual drives to be supplied with power from the primary drive system. The primary drive system may be adapted to be replaceable.

The primary drive system may have a primary drive source. The primary drive source may be a combustion engine, a fuel cell, an accumulator or an external power source located outside the road construction machine.

The road construction machine may have a buffer battery. The buffer battery may be used to compensate for load or power peaks. This allows the primary drive system and/or the primary drive source to be dimensioned smaller. The buffer battery may be a direct current battery. The buffer battery may be an alternating current battery. The buffer battery may be arranged between the primary drive system and the one or more individual drives.

The road construction machine may have a first converter. The first converter may be arranged between the primary drive system and the one or more individual drives. The first converter may be arranged between the primary drive system and the buffer battery. The first converter may be arranged between the interface and the buffer battery.

The first converter may be a first inverter, a first rectifier or a first transformer. The first converter may be required if the current supplied by the primary drive system does not correspond to the current that may be stored by the buffer battery or the current required by the individual drives. For example, a rectifier is required if alternating current is generated by the primary drive system and a direct current battery is used as a buffer battery. An inverter is required if direct current is generated by the primary drive system and an alternating current battery is used as a buffer battery. A transformer may be required if the voltage supplied by the primary drive system does not correspond to the voltage of the buffer battery.

The road construction machine may have a second converter. The second converter may be arranged between the buffer battery and the one or more individual drives. If the current (direct or alternating current) stored in the buffer battery does not correspond to the current required by the individual drives, the second converter is required. The second converter may be an inverter. The second converter may be a rectifier. Several second converters may also be arranged between the buffer battery and the individual drives. The power distributor may be arranged between the one or more converters and the individual drives.

The road construction machine may have a power distributor. The power distributor may be arranged between the buffer battery and the individual drives. The power distributor may be arranged between the buffer battery and one or more converters.

The primary drive system may have a combustion engine, in particular a diesel engine. The primary drive system may have a fuel tank and/or a biofuel tank.

The primary drive system may have a gas engine. The primary drive system may have a hydrogen tank or a pressure tank, in particular a pressure tank for natural gas and/or liquefied petroleum gas.

The primary drive system may have a fuel cell. The primary drive system may have a hydrogen tank or a pressure tank, in particular a pressure tank for natural gas and/or liquefied petroleum gas.

The primary drive system may have an accumulator. The primary drive system and have a third converter. The third converter may be an inverter, a rectifier or a transformer.

The primary drive system may have lifting points (e.g., lifting points 35 shown in FIGS. 3-5). The lifting points could be adapted to provide an application surface and/or an application point for a crane or forklift. The lifting points may be attached to the primary drive source. The lifting points may be attached to a container, in particular a fuel tank, a pressure tank and/or a hydrogen tank, of the primary drive system.

The lifting points may be attached to a combustion engine, a fuel cell, an accumulator, a fuel tank, a pressure tank, a hydrogen tank, or any combination thereof. For example, if the primary drive system comprises a combustion engine and a fuel tank, the lifting points may be attached to the combustion engine and the fuel tank. For example, if the primary drive system comprises a gas engine and a pressure tank, the lifting points may be attached to the gas engine and the pressure tank. If the primary drive system comprises a fuel cell and a hydrogen tank, for example, the lifting points may be attached to the fuel cell and the hydrogen tank.

The road construction machine may have different primary drive systems. For example, the road construction machine may have a first primary drive system and a second primary drive system. The first primary drive system or the second primary drive system may comprise a combustion engine and a fuel tank. The first primary drive system or the second primary drive system may comprise a gas engine and a pressure tank. The first primary drive system or the second primary drive system may comprise a hydrogen tank and a fuel cell. The first primary drive system or the second primary drive system may comprise an accumulator and an overhead line, power rail and/or trailing cable connected to an external power source.

The different primary drive systems, in particular the first primary drive system and the second primary drive system, may have the same dimensions. The different primary drive systems, in particular the first primary drive system and the second primary drive system, may have a uniform hole pattern for a screw and/or bolt connection. The different primary drive systems, in particular the first primary drive system and the second primary drive system, may have a uniform locking component. The uniform locking component may be part of a locking system, which in particular enables the primary drive system to be connected and/or locked to the road construction machine. The locking system may be automatic and/or function automatically. The uniform locking component may be part of a snap connection.

The first primary drive system and the second primary drive system may be installed in parallel on the road construction machine. The first primary drive system and the second primary drive system may be adapted as alternative modules. In particular, this means that if the first primary drive system is installed in the road construction machine, the second primary drive system is mounted outside the road construction machine and vice versa.

The interface may be adapted automatically. The interface may comprise an automatic locking and unlocking mechanism. The interface may comprise a releasable mechanical connection. The releasable mechanical connection may be adapted to secure the primary drive system, in particular the primary drive source, to the road construction machine. The releasable mechanical connection may be adapted to be automatic. The interface may comprise a first releasable electrical connection. The first releasable electrical connection may be adapted to electrically connect the primary drive system to the buffer battery. The interface may comprise a second releasable electrical connection. The second releasable electrical connection may be adapted to provide an electrical connection between the primary drive system and a control system (e.g., control system 34 shown in FIG. 1) of the road construction machine. The second releasable electrical connection may be adapted to enable communication between the primary drive system and the rest of the road construction machine, in particular the control system. The interface may comprise an automatic locking and unlocking mechanism for the releasable mechanical connection, the first releasable electrical connection and/or the second releasable electrical connection. The interface may be adapted to receive one or more electrical cables, which are in particular received in cylindrical openings of the interface, for example. The interface may comprise at least one latching arm and at least one locking arm, which are adapted to engage with each other. The interface may comprise a magnetic coupling system. The interface may comprise a plug and an opening, adapted to receive the plug. The interface may comprise a snap-fit connection. The interface may comprise a sealing element, such as an O-ring.

The road construction machine may comprise a control system. The control system may be adapted to recognize the type of primary drive system, in particular the primary drive source. For example, the control system may identify whether the primary drive system comprises a combustion engine, a gas engine and/or a fuel cell and/or is connected to an external power source, such as a public power grid or on-site power generation, by communicating with the primary drive system, in particular via the second releasable electrical connection.

The control system may be adapted to display drive-specific information to a user based on the type of primary drive system, in particular to visualize it on an operator display. If the primary drive system comprises a tank, for example a fuel tank, a pressure tank and/or a hydrogen tank, the control system may be adapted to display the filling status of the tank. The control system may also be adapted to display the current power of the combustion engine, the gas engine or the fuel cell. The control system may be adapted to activate or deactivate certain functions depending on the type of primary drive system. For example, certain displays or buttons on the operator display may be grayed out or hidden depending on the primary drive system.

The control system may be adapted to control the road construction machine depending on the primary drive system. The control system may be adapted to control the one or more individual drives of the road construction machine depending on the primary drive system.

The individual drives (e.g., actuators) may be electric drives for executing translatory and/or rotatory movements or electrically powered hydraulic units for executing translatory and/or rotatory movements.

The road construction machine may be a road paver. The road paver may have a material container (receptacle or hopper) for receiving paving material, and one or more working aggregates such as a material transport device (e.g., a conveyor), a distribution device (e.g., distribution screw/auger), a screed, an automatic leveling system, one or more electrically operated heating devices (e.g., a screed heating system), and/or a scraper belt. The road paver may have the following individual drives: Rotary drives for the driving gear, rotary drives for the scraper conveyors, rotary drives for the screws, linear drives for a hopper wall cylinder, linear drives for the leveling cylinder, linear drives for raising and lowering the screed, linear drives for telescoping the screed, and rotary drives or a rotary drive system for the compaction equipment. A screed heating system may be connected to the electrical interface.

The road construction machine may be a feeder vehicle. Feeder vehicles are road construction machines that are used to supply road pavers with paving material. For this purpose, the feeder vehicle is placed in front of the road paver in the working direction. Such a feeder vehicle is known from EP 2377995 A1. The feeder vehicles generally comprise a material hopper and a conveyor device for transporting paving mix from the feeder material hopper into the material hopper of the road paver.

The road construction machine may be a milling machine. Milling machines or cold milling machines are known as road construction machines for working on roadways, for example for road surface removal. A cold milling machine typically has a frame that is powered by drive units fitted with tracks or wheels. The frame carries the energy supply module, an operator station, a milling drum and conveyors.

The road construction machine may be a slipform paver. Slipform pavers are road construction machines that are used in the construction of concrete pavements. Concrete pavements are used for a wide variety of applications, such as the construction of highways, trunk roads, airport runways, container storage areas or railroad tracks. The slipform paver may have machine frames that may be telescoped in the longitudinal and transverse directions, smoothing equipment (super smoother, transverse smoother) and hydraulic units for powering the smoothing equipment.

According to a second aspect, the disclosure relates to a method for assembling a road construction machine. The road construction machine comprises one or more individual drives adapted for powering the road construction machine, in particular for powering a driving gear and/or working aggregates of the road construction machine.

The method comprises the following steps, among others: Coupling the one or more individual drives to the driving gear and/or the working aggregates. Connecting the one or more of the individual drives to an interface. Inserting a first primary drive system into the road construction machine. Connecting the first primary drive system to the interface. The person skilled in the art understands that the individual process steps can, if technically possible, be carried out in any order.

The method may further comprise disconnecting the first primary drive system from the interface. The method may further comprise removing the first primary drive system from the road construction machine. The method may further comprise inserting a second primary drive system into the road construction machine. The method may further comprise connecting the second primary drive system to the interface.

The method may further comprise inserting a buffer battery into the road construction machine. The method may further comprise connecting the first and/or second primary drive system to the buffer battery, in particular via the interface.

According to a third aspect, the disclosure relates to a road construction machine comprising a chassis, a driving gear, a plurality of working aggregates for installing or removing a road surface and/or for conveying a paving material, a primary drive system for powering transmissions of the road construction machine, in particular the driving gear and/or the working aggregates of the road construction machine, wherein the primary drive system comprises a plurality of individual drives for mechanical coupling with the transmissions and an energy supply system for supplying the individual drives with electric current. At least three separate energy supply paths, each comprising a separate primary drive source or each connected to a separate primary drive source, may be integrated/able to be integrated in the energy supply system, in particular independently or separately from one another. The energy supply module is supported by the chassis.

An energy supply path may be an energy supply module of the energy supply system. A structural component of the energy supply path may be temporarily integrated into the energy supply system, preferably by being mounted in the installation space provided for the energy supply module.

Each of the at least three separate energy supply paths may be integrated individually and/or temporarily in the energy supply system. It would also be possible to integrate several of the at least three separate energy supply paths in combination in the energy supply system, in particular temporarily. It would also be possible to integrate all of the at least three separate energy supply paths in together in the energy supply system. It would also be possible for more than three separate energy supply paths, for example four to six or five separate energy supply paths, to be integrated into the energy supply system.

Each of the at least three separate energy supply paths may individually provide electrical power for powering the individual drives and/or the primary drive system may comprise only electrically operable individual drives. For the energy supply system with at least three separate energy supply paths, each comprising a separate primary drive source, the road construction machine may have an installation platform. On the installation platform, a separate installation space may be available for each component of the three separate energy supply paths. This may allow all of the at least three separate energy supply paths to be accommodated simultaneously on the road construction machine, in particular on the installation platform, preferably connected in parallel to each other. It would also be possible to accommodate the at least three separate energy supply paths, each comprising a separate primary drive source, in the energy supply system at different times (separated in time from one another). For example, only one of the at least three separate energy supply paths may be temporarily accommodated in the installation space of the road construction machine, in particular the installation platform, specifically provided for these energy supply paths (i.e., the component of this energy supply path, for example a fuel tank, a combustion engine, a generator, may be integrated in the energy supply system). The other installation spaces for the other at least two energy supply paths may remain empty. Depending on requirements or depending on the available energy source, the energy supply path in the road construction machine may be removed, i.e., the component of this energy supply path may be removed from the road construction machine. Subsequently, for example, a component of another energy supply path of the further at least three energy supply paths may be placed in the installation space of the road construction machine, in particular the installation platform, specifically provided for these energy supply paths (i.e., the component of this energy supply path, for example a hydrogen tank or a fuel cell, may be integrated into the energy supply system). This allows the primary drive source of the road construction machine to be replaced. The primary drive source of the road construction machine may be selected from different primary drive sources (e.g., combustion engine, fuel cell, accumulator or external power source).

The disclosure may offer several advantages: For example, embodiments according to the disclosure may reduce the number of road construction machine types and provide a road construction machine type in which the primary drive source may be easily exchanged depending on the energy source available or temporarily suitable in the distribution destination (or, for example, depending on the applicable emission standard), before delivery or during the service life. This makes it possible to use different primary energy sources to power the same road construction machine. A customer may select the drive concept or the necessary energy supply path for the road construction machine in accordance with respective local legislation and/or resource availability.

The production of a single machine type for all distribution targets advantageously reduces the variety of components and significantly reduces construction costs. In this road construction machine or road construction machine type, the energy supply system has a modular design. In the energy supply system, there is in each case an installation system or a installation space for the desired/planned primary drive source, in particular for the energy supply paths comprising the desired primary drive source.

A further advantage of the disclosure is that several separate energy supply paths, each comprising a separate primary drive source, may be provided simultaneously in the same road construction machine. This allows the individual drives to be powered simultaneously or at a moving time from each other via several different primary drive sources. Depending on requirements or local emissions legislation, the individual drives may be powered only by emission-free primary drive sources (e.g., fuel cell or accumulator or external power source such as the public power grid).

The primary drive source may be a combustion engine, for example a diesel engine, a gas engine or a hydrogen engine. The combustion engine may have a generator or be mechanically connected to a generator. The primary drive source may be a galvanic cell, for example a fuel cell, an accumulator or a battery. The fuel cell may be a hydrogen-oxygen fuel cell. The fuel cell can convert a chemical reaction energy of a continuously supplied fuel and an oxidizing agent into electrical power. The accumulator may be a rechargeable device that stores electrical power on an electrochemical basis. When the accumulator is discharged, stored chemical energy is converted into electrical power by the electrochemical redox reaction. The accumulator may be a lithium-ion battery. The term “battery” can mean a primary battery that is not rechargeable or a secondary battery (or accumulator) that is rechargeable. The primary drive source may be an external power source located outside the road construction machine, for example a public or private power grid.

The primary drive system may have an electrical interface between the respective individual drives and the energy supply system. Each of the energy supply paths of the energy supply system integrated or able to be integrated in the road construction machine at the desired time may be connected to this electrical interface. In the electrical interface, the respective electrical connecting elements of the individual drives and the energy supply paths are brought into contact with each other for the transmission of electrical current. Through the electrical interface, each of the separate energy supply paths can supply the individual drives with electrical power individually or independently of each other.

Each of the individual drives and/or each of the energy supply paths may be connected to the electrical interface, preferably in parallel. The individual drives may be connected downstream of the electrical interface. The energy supply paths may be connected upstream of the electrical interface. A switch may be connected to the electrical interface for each of the individual drives and/or for each of the energy supply paths.

The electrical interface may be a power distributor. The electrical interface may be a power distributor. In the power distributor, the energy supply may be divided into individual circuits for the respective individual drives. The electrical interface may comprise a converter, preferably an inverter or a rectifier. The electrical interface may be a converter, preferably an inverter or a rectifier. The converter may comprise a power distributor. In the converter, the electric current (direct current or alternating current) supplied by each of the at least three separate energy supply paths may be converted/changed. The individual drives may be powered by alternating current. In this case, the converter may be an inverter. The inverter can convert the electrical direct current supplied by each of the at least three separate energy supply paths into alternating current.

A first energy supply path of the energy supply system may comprise a first fuel tank, a first combustion engine, a generator, and preferably a rectifier. These components may be arranged in this order on the energy supply system and form the first energy supply path. The rectifier of the first energy supply path may be connected directly to the electrical interface or to the inverter or directly to a buffer battery connected upstream of the electrical interface. The buffer battery may be used to supply power to individual drives in the event of a power failure or to compensate for different load states (voltage stabilization, interception of short-term load peaks). It would also be conceivable for the generator of the first energy supply path to be connected directly to the electrical interface, wherein the electrical interface preferably has a power distributor and/or a frequency converter. The first energy supply path may have several fuel tanks, for example a diesel fuel tank and a biodiesel fuel tank, wherein preferably both of the tanks are connected to the combustion engine or to the diesel engine.

The first energy supply path of the energy supply system may have a second fuel tank and a second combustion engine. The second fuel tank may be a fuel gas tank and the second combustion engine may be a gas engine or a hydrogen engine. Natural gas or hydrogen may be stored in the fuel gas tank. The first and second combustion engines may be mechanically coupled to the generator.

A second energy supply path of the energy supply system may have a hydrogen tank, preferably a separate tank for oxidizing agent and a fuel cell. The hydrogen tank and/or the fuel cell may be connected directly to the electrical interface or directly to a buffer battery connected upstream of the electrical interface.

A third energy supply path of the energy supply system may have an accumulator, preferably a replaceable accumulator. The accumulator of the third energy supply path may be connected directly to the electrical interface.

The third energy supply path may have a first power connection, wherein the power connection is connected to an external power source located outside the road construction machine. The power source may be a public or private power grid, or a charging vehicle with an energy storage (or accumulator).

The third energy supply path of the energy supply system may have a rectifier connected between the accumulator and the first power connection. This allows the accumulator to be charged.

A fourth energy supply path of the energy supply system may have a second power connection, which is connected to an external power source located outside the road construction machine, and a power line between the second power connection and the electrical interface. This allows the individual drives to be supplied directly from the external power source.

One or more electrically operated heating devices may be connected to the electrical interface in order to be supplied with electrical current by the energy supply system of the road construction machine.

According to a fourth aspect, the disclosure relates to a method for setting up a primary drive system of a road construction machine for powering transmissions of the road construction machine, in particular a driving gear and/or working aggregates of the road construction machine, wherein the primary drive system has a plurality of individual drives and an energy supply system for supplying the individual drives with electric current, the method having the following steps: coupling the individual drives to the transmissions, connecting the individual drives to an electrical interface, attaching a first energy supply path comprising a fuel tank, a combustion engine, a generator, and preferably a rectifier in the energy supply system, and connecting the rectifier directly to the electrical interface or directly to a buffer battery connected upstream of the electrical interface, and/or attaching a second energy supply path comprising a hydrogen tank and a fuel cell in the energy supply system and connecting the fuel cell directly to the electrical interface or directly to a buffer battery connected upstream of the electrical interface, and/or attaching a third energy supply path comprising an accumulator, preferably a replaceable accumulator in the energy supply system and connecting the accumulator directly to the electrical interface, and/or attaching a fourth energy supply path comprising a power connection connected to an external power source located outside the road construction machine and connecting a power line between the power connection and the electrical interface.

All the features disclosed above in connection with the road construction machine according to the disclosure may be used individually or together in the method according to the disclosure.

The road construction machine according to the first or third aspect of the disclosure may be manufactured or assembled using method steps of the method according to the second or fourth aspect of the disclosure. The method according to the second or fourth aspect of the disclosure may be performed with a road construction machine according to the first or third aspect of the disclosure. The road construction machine according to the first aspect of the disclosure may be extended or combined with features of the road construction machine according to the third aspect of the disclosure. The road construction machine according to the third aspect of the disclosure may be extended or combined with features of the road construction machine according to the first aspect of the disclosure.

The expressions “first”, “second”, “third” and “fourth” are to be understood merely as designations for a particular element or component and do not necessarily indicate a particular order or arrangement of said components or elements. For example, the presence of a fourth element/component does not necessarily imply the presence of a first, second or third element/component and vice versa.

### BRIEF DESCRIPTION OF THE DRAWINGS

Exemplary embodiments are explained below with reference to the below figures:

FIG. 1 is a schematic perspective view of a road construction machine in the form of a road paver;

FIG. 2 is a schematic representation of a drive system of a road construction machine according to the disclosure;

FIG. 3 is a schematic representation of a primary drive system in an embodiment of a road construction machine according to the disclosure;

FIG. 4 is a schematic representation of a primary drive system in a further embodiment of a road construction machine according to the disclosure; and

FIG. 5 is a schematic representation of a primary drive system in a further embodiment of a road construction machine according to the disclosure.

### DETAILED DESCRIPTION

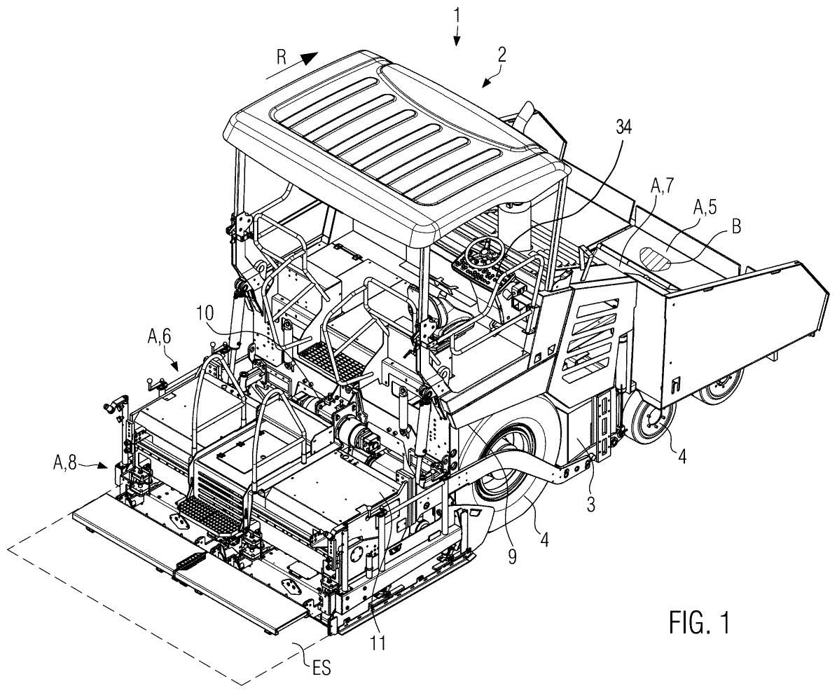

FIG. 1 shows a perspective view from the diagonal rear of a road construction machine 1, which is a road paver 2 for installing a road surface ES. The road paver 2 is self-propelled. The road paver 2 comprises a chassis 3, a driving gear 4, and working aggregates A (e.g., working components), such as a material hopper 5 for receiving a paving material B (asphalt mix), a screed 6 mounted on the chassis 3 so as to be adjustable in height and towed in the driving direction R, and a conveyor unit 7, comprising a conveyor belt, for providing the paving material B from the material hopper 5 of the road paver 2 to the screed 6 through a transverse distribution device 8 (with a distribution screw) of the road paver 2.

The road paver 2 comprises a primary drive system 9 for powering gears of the road paver 2, in particular the driving gear 4 and/or the working aggregates A of the road paver 2. The road paver 2 comprises several individual drives 10 (e.g., actuators), which can be powered electrically. The individual drives 10 may be, for example, rotary drives for the driving gear 4, rotary drives for the conveyor unit 7, rotary drives for the distribution screws of the transverse distribution device 8, linear drives for a hopper wall cylinder, linear drives for the leveling cylinder, linear drives for raising and lowering the screed 6, linear drives for telescoping the screed 6 and rotary drives or a rotary drive system for the compaction devices of the screed 6. The road paver 2 also comprises a screed heating system 11.

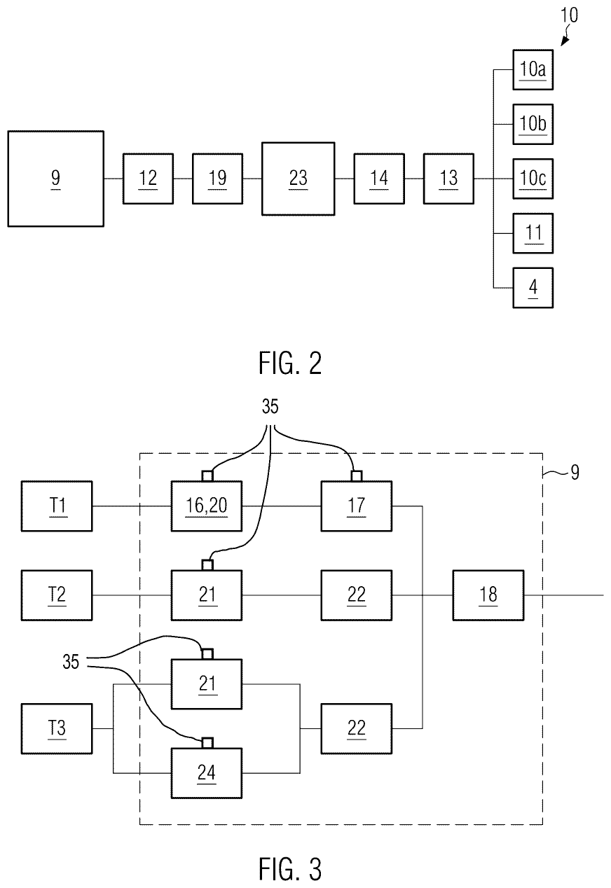

The components of the drive system of the road construction machine 1 are shown schematically in FIG. 2. The road construction machine 1 comprises a primary drive system 9 and at least one individual drive 10 (e.g., actuator). For example, the road construction machine 1 may comprise three individual drives 10, such as at least one hydraulic aggregate 10a for executing translatory movements, at least one first electric drive 10b for executing translatory movements and at least one second electric drive 10c for executing rotatory movements, as shown in FIG. 2. The individual drives 10 are operated with power from the primary drive system 9. FIG. 2 also shows a screed heating system 11, which may also be operated with power from the primary drive system 9. The driving gear 4 may also be operated with power from the primary drive system 9. In particular, the individual drives 10 may power or interact with the working aggregates A, such as the material hopper 5, the screed 6, the conveyor unit 7 and/or the transverse distribution device 8.

A buffer battery 23 is arranged between the primary drive system 9 and the individual drives 10. The buffer battery 23 is used to compensate for load peaks. The buffer battery 23 allows the primary drive system 9 to be dimensioned smaller. The buffer battery 23 may be a direct current battery or an alternating current battery. A first converter 19 may be arranged between the primary drive system 9 and the buffer battery 23. If the current (direct or alternating current) generated by the primary drive system 9 does not correspond to the current stored in the buffer battery 23, the first converter 19 is required. The first converter 19 may be a rectifier or an inverter. For example, if direct current is generated by the primary drive system 9 and an alternating current battery is used as the buffer battery 23, the first converter 19 is an inverter. If alternating current is generated by the primary drive system 9 and a direct current battery is used as a buffer battery 23, the first converter 19 is a rectifier. Alternatively or additionally, the first converter 19 may comprise a transformer.

A second converter 14 may be assembled between the buffer battery 23 and the individual drives 10. If the current (direct or alternating current) stored in the buffer battery 23 does not correspond to the current required by the individual drives 10, the second converter 14 is required. The second converter 14 may be an inverter or a rectifier. Several second converters 14 may also be arranged between the buffer battery 23 and the individual drives 10.

A power distributor 13 is arranged between the buffer battery 23 and the individual drives 10. The power distributor 13 may be arranged between the buffer battery 23 and the one or more converters 14. The power distributor 13 may be arranged between the one or more converters 14 and the individual drives 10. The power distributor 13 may include, for example, various electrical components and/or electronic circuitry (e.g., circuit breaker, sensors, controller) to distribute electrical power from a main power source to separate circuits or devices.

An interface 12 is arranged between the primary drive system 9 and the individual drives 10. The primary drive system 9 may be coupled to the individual drives 10 via the interface 12. The interface 12 may be arranged between the primary drive system 9 and the buffer battery 23. The interface 12 may be arranged between the primary drive system 9 and the first converter 19. The interface 12 may be arranged between the buffer battery 23 and the first converter 19. The interface 12 may be arranged between the buffer battery 23 and the individual drives 10. The interface 12 may be adapted to receive one or more electrical cables, which are in particular received in cylindrical openings of the interface 12, for example. The interface 12 may comprise at least one latching arm and at least one locking arm, which are adapted to engage with each other. The interface 12 may comprise a magnetic coupling system. The interface 12 may comprise a plug and an opening, adapted to receive the plug. The interface 12 may comprise a snap-fit connection. The interface 12 may comprise a sealing element, such as an O-ring.

FIG. 3 shows a primary drive system 9 in a first embodiment. The parallel lines may be seen as alternatives. The primary drive system 9 comprises a fuel tank 16 or a bio-fuel tank 20, which feeds a combustion engine 17, for example a diesel engine. The primary drive system 9 further comprises a generator 18. The combustion engine 17 operates the generator 18, which generates alternating current. The alternating current generated by the generator 18 is fed to the buffer battery 23. The fuel tanks 16, 20 may be refilled on site (operating site) by mobile fuel supply vehicles T1 (tanker trucks). However, the fuel supply vehicles are not part of the primary drive system 9 installed in the road construction machine 1.

Alternatively, the primary drive system 9 may comprise a pressure tank 21, filled with gas, in particular natural gas or liquefied petroleum gas, and a gas engine 22. The gas engine 22 operated with gas from the pressure tank 21 also operates the generator 18. The pressure tank 21 may be refilled on site (operating site) by mobile fuel supply vehicles T2 (tanker trucks).

Alternatively, the primary drive system 9 may comprise a pressure tank 21 or hydrogen tank 24, filled with hydrogen, and a gas engine 22. Alternatively, a tank for LOHC (liquid organic hydrogen carriers) or a tank for oxidizing agents (not shown) may be used. The gas engine 22 powered by hydrogen from the pressure tank 21 or hydrogen tank 24 also powers the generator 18. The pressure tank 21 may be refilled on site (operating site) by mobile hydrogen supply vehicles T3 (tank trucks).

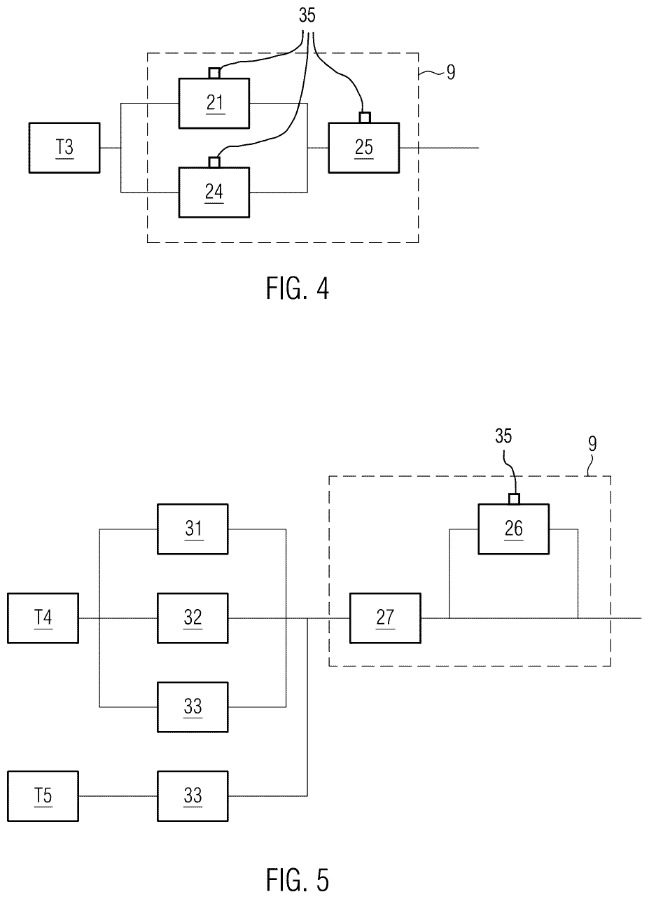

FIG. 4 shows a primary drive system 9 in a further embodiment. The parallel lines may be seen as alternatives. The primary drive system 9 comprises a pressure tank 21 or hydrogen tank 24, filled with hydrogen, and a fuel cell 25. Alternatively, a tank for LOHC (liquid organic hydrogen carriers) or a tank for oxidizing agents (not shown) may also be used. The fuel cell 25 is powered by hydrogen from the pressure tank 21 or hydrogen tank 24. The power generated by the fuel cell 25 is routed to the buffer battery 23. The hydrogen tank 24 (also the tank for oxidizing agent) may be refilled on site (operating site) by mobile hydrogen supply vehicles T (tank trucks).

FIG. 5 shows a primary drive system 9 in a further embodiment. The primary drive system 9 may comprise a third converter 27. The third converter 27 is supplied with power from the public power grid T4. The public power grid T4 may be tapped via an overhead power line 31, a power rail 32 and/or a trailing cable 33. Alternatively, a local power generation T5, for example a wind turbine, a photovoltaic system and/or a generator, may be used, which is connected to the third converter 27 via a trailing cable 33. Power is conducted from the third converter 27 to the buffer battery 23. Optionally, an accumulator 26 is arranged between the third converter 27 and the buffer battery 23. The third converter 27 may be a rectifier, an inverter or a transformer.

The road construction machine 1 can also be a feeder vehicle for feeding a road paver, a milling machine or a slipform paver.

As one skilled in the art would understand, the above-mentioned control system 34 for the road construction machine, as well an any other system, unit, controller, machine, apparatus, element, sensor, detector, device, component, subsystem, arrangement, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such system, unit, controller, machine, apparatus, element, sensor, detector, device, component, subsystem, arrangement, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

What is claimed is:

1. A road construction machine comprising:
a chassis;
a driving gear;
one or more working aggregates for installing or removing a road surface and/or for conveying a paving material;
one or more individual drives which are adapted to power the driving gear and/or the working aggregates;
a primary drive system for powering the one or more individual drives of the road construction machine; and
an interface, wherein the interface is adapted to connect the primary drive system in a coupleable manner to the one or more individual drives to enable the one or more individual drives to be supplied with power from the primary drive system, and the primary drive system is adapted to be replaceable.

2. The road construction machine according to claim 1, wherein the primary drive system has a primary drive source, wherein the primary drive source is selected from the following group: a combustion engine, a fuel cell, an accumulator or an external power source located outside the road construction machine.

3. The road construction machine according to claim 1, further comprising a buffer battery arranged between the primary drive system and the one or more individual drives.

4. The road construction machine according to claim 3, wherein the buffer battery is a direct current battery or an alternating current battery.

5. The road construction machine according to claim 3, further comprising a first converter arranged between the primary drive system and the buffer battery.

6. The road construction machine according to claim 5, wherein the first converter comprises a first inverter, a first rectifier or a first transformer.

7. The road construction machine according to claim 3, further comprising one or more second converters arranged between the buffer battery and the one or more individual drives.

8. The road construction machine according to claim 7, wherein each of the one or more second converters comprises a second inverter or a second rectifier.

9. The road construction machine according to claim 3, further comprising a power distributor arranged between the buffer battery and the one or more individual drives.

10. The road construction machine according to claim 9, further comprising one or more second converters arranged between the buffer battery and the one or more individual drives, wherein the power distributor is arranged between the one or more second converters and the buffer battery or between the one or more second converters and the one or more individual drives.

11. The road construction machine according to claim 1, wherein the primary drive system has lifting points.

12. The road construction machine according to claim 11, wherein the lifting points are attached to a combustion engine, a fuel cell, an accumulator, a fuel tank, a pressure tank, a hydrogen tank, or any combination thereof.

13. The road construction machine according to claim 1, wherein the road construction machine comprises several different primary drive systems.

14. The road construction machine according to claim 1, wherein the interface comprises a releasable mechanical connection, a first releasable electrical connection and/or a second releasable electrical connection.

15. The road construction machine according to claim 1, further comprising a control system, wherein the control system is adapted to recognize type of the primary drive system.

16. The road construction machine according to claim 15, wherein drive-specific information is displayable to a user depending on the primary drive system.

17. The road construction machine according to claim 15, wherein the control system is adapted to control the road construction machine depending on the primary drive system.

18. The road construction machine according to claim 17, wherein the control system is adapted to control the one or more individual drives of the road construction machine.

19. A method for assembling a road construction machine comprising one or more individual drives, wherein the individual drives are adapted for powering a driving gear and/or working aggregates of the road construction machine, the method comprising:
coupling the one or more individual drives to the driving gear and/or the working aggregates;
connecting the one or more individual drives to an interface;
inserting a first primary drive system into the road construction machine; and
connecting the first primary drive system to the interface.

20. The method according to claim 19, further comprising:
disconnecting the first primary drive system from the interface;
removing the first primary drive system from the road construction machine;
inserting a second primary drive system into the road construction machine; and
connecting the second primary drive system to the interface.
